(19) United States
(12) Patent Application Publication
(10) Pub. No.: US 2004/0135988 A1
(43) Pub. Date: Jul. 15, 2004

(54) Method and device for producing an intermediate supporting strip by welding and involving a subsequent heat treatment

(76) Inventor: Robert Link, Munchen (DE)

Correspondence Address: SCHIFF HARDIN, LLP, PATENT DEPARTMENT, 6600 SEARS TOWER, CHICAGO, IL, 60606-6473, US

(21) Appl. No.: 10/471,217

(22) PCT Filed: Feb. 11, 2002
(86) PCT No.: PCT/EP02/06405

(30) Foreign Application Priority Data
Sep. 24, 2001 (WO) PCT/EP01/11033

(51) Int. Cl. G03B 1/00

(52) U.S. Cl. 355/133

(57) ABSTRACT

The invention relates to a method and device for producing endless strips from plastic films for an intermediate supporting strip in an electrographic printer or copier by welding the ends of a plastic film (10). The ends of the plastic film (10) are placed one atop the other on the faces thereof. The plastic film (10) is held under pressure in the vicinity of the film ends, and the plastic film (10) is heated by radiation to the temperature required for welding the ends. A recrystallization step, optionally carried out by supplying energy, ensues after welding.

The invention is directed to a method and to a device for manufacturing an endless band of plastic for an intermediate carrier band in an electrographic printer or copier.

Intermediate carrier bands are utilized in electrographic printers or copiers in order to generate latent electrostatic images and/or to offer a carrier for toner images to be transfer-printed. For example, an endless band with a photoconductive layer, for example an OPC band (organic photoconducting) is employed as intermediate carrier band, this forming a corresponding electrostatic charge image, what is referred to as a latent charge image, by being exposed according to a predefined image pattern. This latent charge image is then inked with toner material in a developer station; later, this toner image is transferred onto paper or some other recording medium and is fixed thereon.

An endless intermediate carrier band can also serve as transfer band for collecting toner images and conveying these to a transfer printing location. Given, for example, a multi-color printing, a first toner image of a first color is transferred onto the intermediate carrier band. Subsequently, a second toner image with a second color is transferred onto this first toner image, etc. The multi-colored toner images on the intermediate carrier band superimposed on one another in this way are then conveyed to a transfer printing station and transferred onto the recording medium thereat and fixed.

Ends of a plastic film must be connected to one another for manufacturing an endless intermediate carrier band. The weld that thereby arises can be the cause of numerous disruptions. For example, a thickening along the weld leads to increased wear given circulation of the intermediate carrier band. Moreover, the material properties can have changed in the region of the weld, so that this region can generally not be used as photoconductive region or as region for the acceptance of a toner image.

DE 19 832 168 A1 discloses a method and an apparatus for welding thermoplastic synthetics upon employment of laser light. The ends of a thermoplastic plastic film are arranged abutting and can be held with the assistance of a retainer elements and a silica glass plate. Laser light is coupled in via the silica glass plate, as a result whereof the ends are welded to one another. Special measures for producing a uniform weld are not disclosed.

DE 19 516 726 A1 discloses a method for shaping and closing a folding box, whereby plastic layers for packing a welded to one another upon employment of radiation. The welding process is promoted by applying pressure.

DE 3 713 527 A1 discloses the welding of plastic parts whose ends are place flush against one another. The plastic parts are provided with profiles at their ends, so that these profiles can engage in one another. The ends with the profiles are then welded to one another with the assistance of a laser welding device.

EP-A-0 705 682 discloses a method for the thermal joining of substrates of polymers, whereby at least one substrate is coated with a medium that absorbs microwaves. The substrates are then welded to one another in a microwave field.

WO 02/26476 A1 (not enjoying prior publication) of the same assignee discloses a method for manufacturing an endless band for an intermediate carrier band by welding. This document is herewith incorporated by reference into the disclosure of the present application.

It has been shown in practice that the plastic films welded according to the method disclosed by WO 02/26476 A1 often exhibit a modified amorphous structure in the seam region that have [sic] a lower tensile strength under thermal load than the structure of the initial material. As an inhomogeneity, this amorphous structure can also lead to the formation of tension between seam region and the initial material. When the intermediate carrier band manufactured by welding is utilized in an electrographic printer or copier, then it is subjected to a high continuous load under elevated temperature conditions. The service life of a carried band manufactured in this way can be shortened due to the amorphous structure in the seam region.

The invention is based on the object of specifying a method and a device for manufacturing an endless band of thermoplastic synthetic whose surfaces allows high usage given low wear and that has [sic] a high continuous stress.

This object is achieved for a method by the features of claim 1. Advantageous developments are recited in the dependent claims.

According to a further aspect of the invention, a device is recited for manufacturing an endless band of thermoplastic plastic for an intermediate carrier band in an electrographic printer or copier. The advantages obtainable with this device agree with the advantages described for the method.

The invention is explained in greater detail below on the basis of exemplary embodiments according to the Figures of the drawings. Shown are:

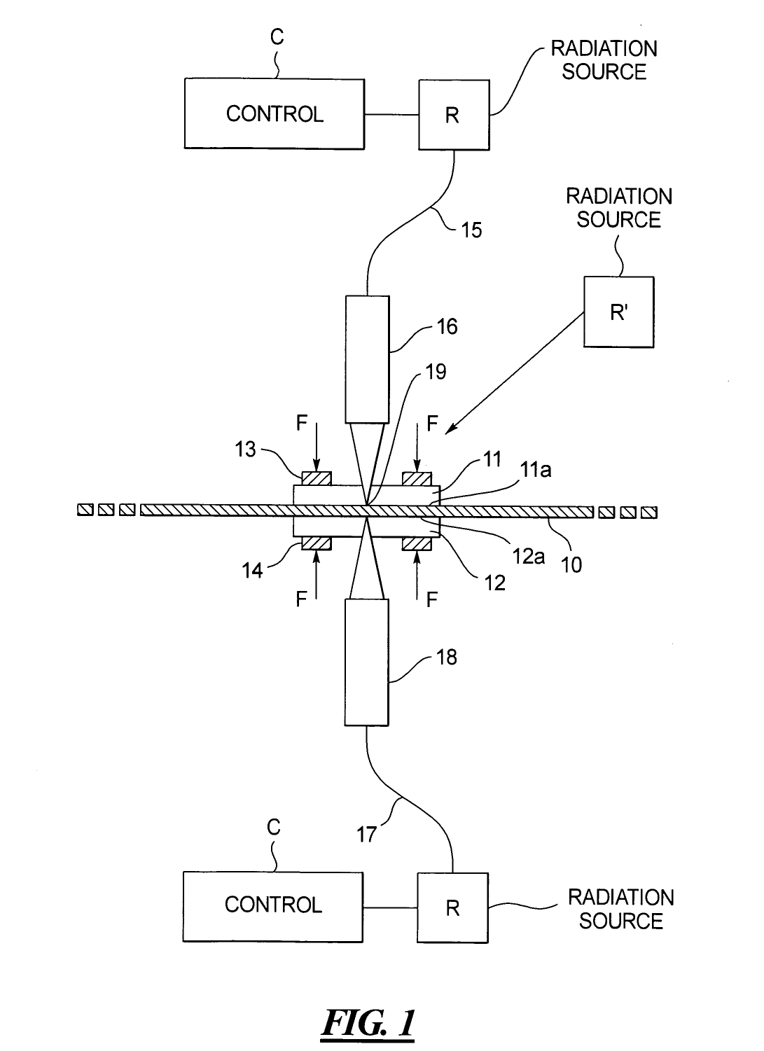

FIG. 1 a schematic illustration of a first exemplary embodiment of an inventive device;

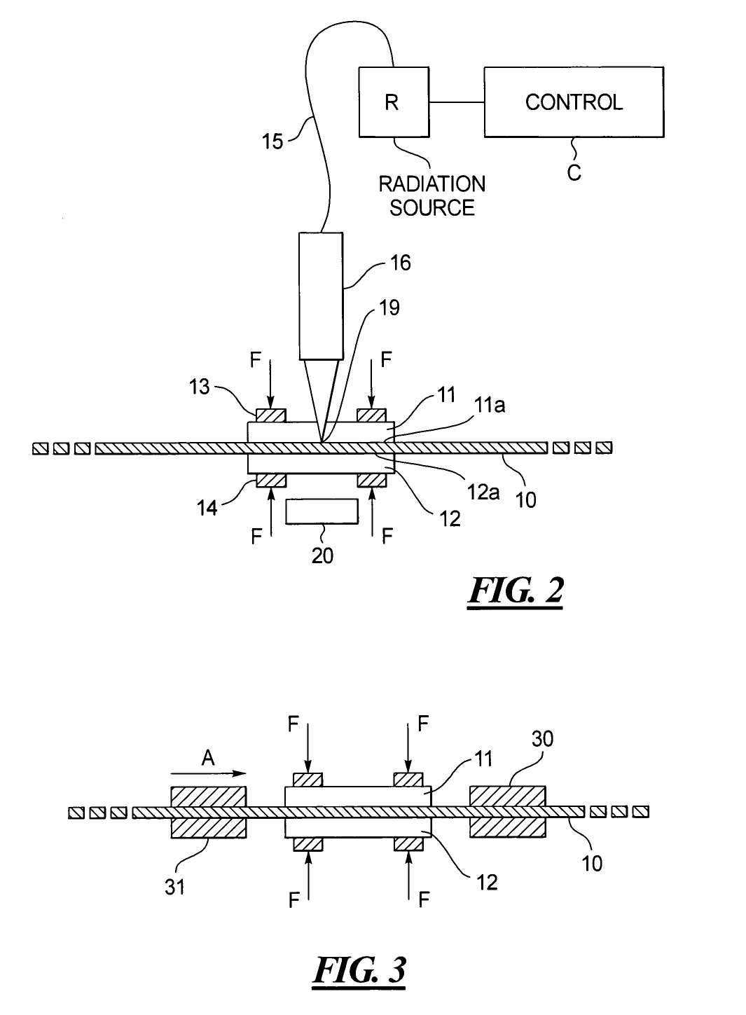

FIG. 2 a schematic illustration of a second exemplary embodiment of an inventive device;

FIG. 3 a schematic illustration of a part of an inventive device that can be additionally employed given the exemplary embodiments according to FIGS. 1 and 2;

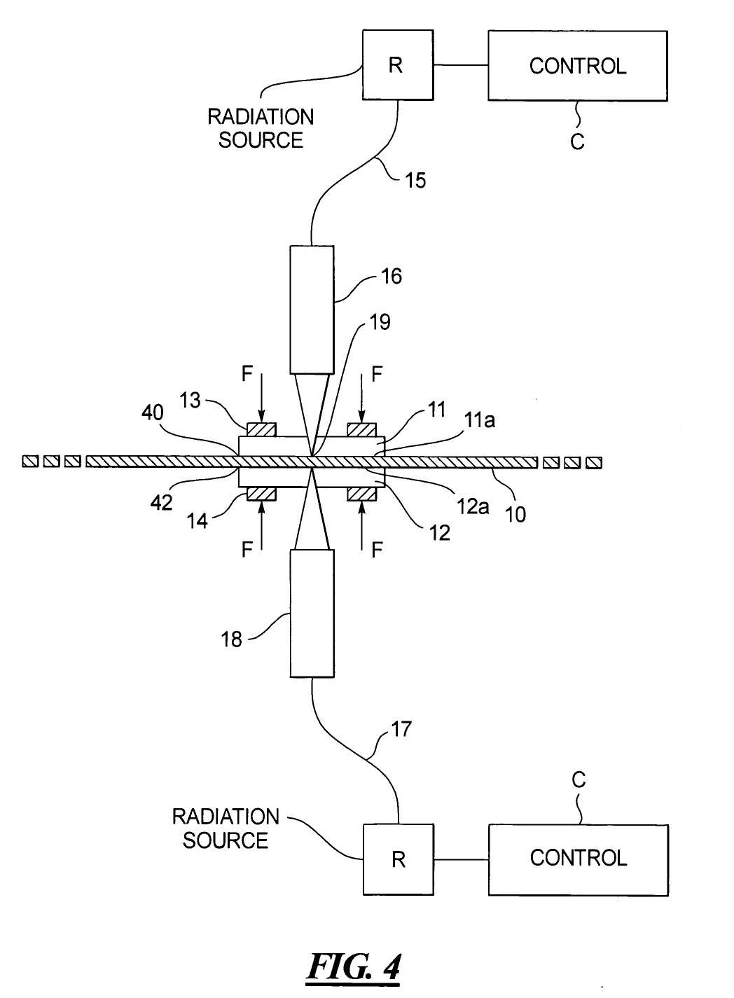

FIG. 4 a schematic illustration of an inventive device according to FIG. 1 with two absorption devices, as fourth exemplary embodiment;

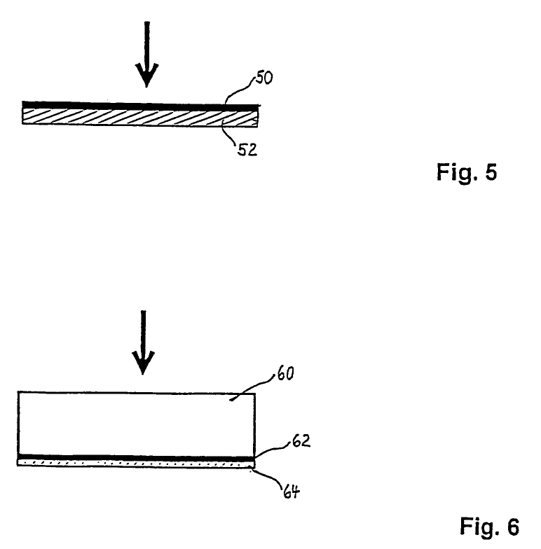

FIG. 5 an absorption device composed of CrNi steel sheet having an absorption layer; and

FIG. 6 an absorption device with a transparent glass pane, a DLC layer and an anti-adhesion coating.

Given the exemplary embodiment according to FIG. 1, a thermoplastic plastic film 10 is placed between a transparent mounting element, for example a glass pane 11, and a transparent counter-mounting element, for example also a glass pane 12, being placed such that the film ends have their end faces lying exactly blunt against one another. Pressing frames 13 and 14 are provided for fixing the plastic film 10 as well as for securing a smooth, non-raised weld, these exerting a prescribed force F onto the glass panes 11, 12 and, thus, on to the plastic film 10. The flat surfaces of the glass panes 11, 12 lying against the plastic film 10 form planar pressing surfaces 11a, 12a. Alternatively, these pressing surfaces 11a, 12a can also be concentric, for example cylinder surfaces. The corresponding glass panes are then elements of generated cylinder surfaces. In a direction perpendicular to the paper plane, the plastic film has a width of at least the width of a standard printing format, for example DIN A4. The glass panes 11, 12 have a length that is greater than this width.

Via radiation-conducting fibers 15 and 17 as well as focussing optics 16 and 18, radiation is supplied from radiation sources (not separately shown) for heating the plastic film 10 beyond the melting point in the region of the adjoining film ends. A weld 19 arises between the film ends as a result thereof. The radiation sources are preferably laser radiation sources, for example instance diode lasers, solid-state lasers, gas lasers or laser diode arrays. Dependent on the absorptivity of the material of the plastic film 10, a specific part of the radiation is absorbed and converted into heat. The pressing surfaces 11a, 12a have a spacing from one another that is determined by the thickness of the plastic film 10 in its cold condition. This spacing is preserved when the ends of the plastic film 10 are heated and they melt, i.e. the force F is selected correspondingly high. The molten material then distributes along the bluntly abutting ends with a thickness corresponding to this spacing.

As a result of simultaneous irradiation of the plastic film 10 from both sides via the focussing optics 16 and 18, a uniform weld 19 can be achieved over the entire thickness of the plastic film 10, which is especially advantageous given film materials with good absorbency. The counter-mounting element 12 is then composed of a material that is transparent for the radiation, for instance glass. This is particularly advantageous given film materials with a small penetration depth of the radiation that is less than half the film thickness. A noteworthy transmission part of the radiation is then no longer present.

For improving the quality of the welding process and for compensating film material fluctuations, it is also expedient to measure the temperature in the region of the weld 19. In a control circuit, the temperature can then be kept constant at a defined value by modifying the radiation capacity.

In the exemplary embodiment according to FIG. 2, wherein identical elements are provided with the same reference characters, as in the other Figures, a radiation source is provided at only one side of the plastic film 10 as well as the mounting element 11 and the pressing frame 13, said radiation source supplying radiation for the weld 19 via the radiation conducting fiber 15 and the focussing optics 16.

Given a material of the plastic film 10 that is largely impermeable for the radiation and a transparent counter-mounting element 12, a check is additionally implemented in this exemplary embodiment as to whether a gap is still present between the ends of the plastic film 10 to be welded. To this end, a radiation detector 20, for example a photodiode, is arranged at that side of the plastic film 10 facing away from the irradiated side, said radiation detector 20 acquiring a radiation part that potentially passes through an existing gap. The radiation part that passes through is nearly zero only given an exact positioning of the ends of the plastic film. The exact positioning of the ends of the plastic film 10 can be implemented manually or automated, whereby the radiation part that passes through should be minimal.

In a further exemplary embodiment, the thickness of the plastic film 10 and the wavelength of the radiation delivered by the radiation source 15, 16 are matched such to one another that the optical penetration depth of the radiation is less than or equal to half the thickness of the plastic film 10. It is thereby assured that sufficient energy can be supplied to the plastic film 10 in order to be able to correctly weld it.

For improving the efficiency, one of the mounting elements 11 and 12, preferably the counter-mounting element 12, can preferably be fashioned reflective at the appertaining pressing surface 12a. Transmitted radiation is then reflected back into the plastic film 10. The mounting element 12 can, for example, be fashioned as a mirror or as a polished metal sheet, preferably a copper or aluminum sheet, or can comprise a reflection-coated material.

In the above-described exemplary embodiments according to FIGS. 1 and 2 as well as in the exemplary embodiment according to FIG. 3 that is yet to be described, the mounting element 11 and the counter-mounting element 12 can be provided with an anti-adhesion coating (not separately shown), for example Teflon or a hydrophobic DLC coating, at the side of the plastic film 10. A sticking of the plastic film during the welding process is thus avoided.

In order to assure a qualitatively high-grade weld given the device according to FIG. 2 with an irradiation from only one side, the plastic film 10 can also be turned over, so that an irradiation from both sides ensues successively.

In the exemplary embodiment according to FIG. 3, wherein identical elements are provided with the same reference characters as in FIGS. 1 and 2, an additional clamping of the plastic film 10 is provided with the assistance of a rigidly seated clamp element 30 and a movable seated clamp element 31. The motion of these clamp element 30 and 31 for pressing the end of the plastic film 10 together is indicated with an arrow A. In other exemplary embodiments, both the clamp element 30 as well as the clamp element 31 can be movable seated. The quality, particularly the strength of the weld, can be improved by pressing together with the assistance of the clamp elements 30, 31.

In the exemplary embodiment according to FIG. 4, wherein identical elements are provided with the same reference characters as in FIG. 1, a respective absorption device 40, 42 is additionally introduced between plastic film 10 and mounting element 11, 12. The absorption device 40 is located directly between the mounting element 11 and the plastic film 10 and forms the first pressing surface 11a. The absorption device 42 lies directly between the counter-mounting element 12 and the plastic film 10 and forms the second pressing surface 12a. That side of the absorption device 40, 42 facing toward the radiation source 16 or, respectively, 18 respectively absorbs the emitted radiant energy and converts it into heat that is transmitted onto the ends of the plastic film 10 residing opposite one another and effects the welding. In this exemplary embodiment, thus, arbitrary thermoplastic material can be employed regardless of the respective absorptivity, for example completely transparent plastic film.

In a further exemplary embodiment according to FIG. 5, the absorption device 40, 42 is composed of a thin metal sheet, for example CrNi sheet steel, that is arranged between the plastic film 10 and the mounting element 11, 12. That side of the metal sheet 52 facing toward the irradiated side can be roughened for improved absorption or can be provided with an absorbent coating 50, particularly with black chromium or stove enamel.

In the exemplary embodiment according to FIG. 6, the absorption device 40, 42 is composed of an absorbent layer 62, particularly a hydrophobic DLC layer or a hard-aggregate layer, preferably respectively approximately 0.2-3 μm thick, on a transparent glass pane 60 serving as carrier. The glass pane 60 simultaneously assumes the function of the mounting element 11 or 12 (see FIG. 4). The absorbent layer 62 can be additionally provided with an anti-adhesion layer 64, particularly a DLC coating, nano-composite layer, Teflon or silicone, preferably having a thickness of approximately 0.5-3 μm, at its side facing away from the radiation. A sticking of the plastic film 10 during the welding process is thus avoided.

The inventive method and the inventive device can be generally applied for all thermoplastics. The employment of polyester, polycarbonate or polyamide is especially beneficial, potentially with absorbent additives for balancing the penetration depth of the radiation to be absorbed. Lampblack-filled polyamide or polycarbonate have thereby proven beneficial. The film thickness lies in the range from 50 to 200 μm.

The inventive method and the inventive device serve for the manufacture of endless photoconductor bands, what are referred to as OPC bands (organic photoconducting), as well as transfer bands for electrophotographic devices. The weld is very uniform and has the same thickness as the plastic film. As a result thereof, it is also possible to employ the region of the weld as a latent image carrier or as a toner image carrier. An endless band manufactured in this way can therefore have a short length and the wear in the region of the weld is reduced, and it can be utilized for printing continuous form paper without loss of paper.

A partially crystalline plastic film cam be employed in the described examples for welding the ends of the endless band. For example, the foil ends to be connected thereby lie between two glass planes. The cooling rate from the molten phase of the melted plastic, which is directly related to the degree of crystallinity, is determined by the heat elimination into the plastic material and into the glass panes. Accordingly, this degree of crystallinity in the region of the molten material is essentially dependent on thermal conduction effect and is difficult to influence.

Existing crystalline structures break up in the thermal welding and, thus, in the fluidization of the partially crystalline plastic material. During the subsequent cooling and solidification. these crystalline structures are only partially restored or not restored at all, dependent on the plastic. Let PET be cited here as an example of a plastic whose high degree of crystallinity of approximately 40% becomes nearly zero in the weld region, so that the material is amorphous. The amorphous structure arising in the seam region has a clearly reduced glass transition temperature. This leads to a diminished tensile strength under thermal load.

When a partially crystalline thermoplastic is employed, a recrystallization step wherein the plastic material recrystallizes in the seam region therefore inventively ensues after the welding. For example, the recrystallization step comprises measures wherein the cooling phase for the plastic material is lengthened in the seam region. This can occur by employing materials with a low thermal conductivity. Another possibility is comprises in holding the parts that form the pressure surface at an elevated temperature for a predefined time, so that the cooling process is retarded. For example, the parts forming the pressure surface can be heated before the welding and the welding can then be implemented upon application of further energy. The cooling process is then retarded due to the pre-heating, as a result whereof a recrystallization can occur.

Another possibility of promoting the crystal formation after the welding is comprised in one-time or repeated tempering. After the cooling, the seam region is heated to a temperature below the melting temperature by means of an at least one-time re-application of energy. A predetermined temperature-time diagram is thereby preferably adhered to.

The energy source with which the welding is carried out is preferably also employed for supplying energy for the recrystallization. Given a large-area welding, for example with the assistance of a stationary laser beam widened to form a band, this can continue to irradiate the seam region with reduced power after the welding of the ends of the plastic film. Given a scanning radiation system, an additional beam from an additional radiation source or from the same radiation source that immediately follows the beam for the welding can supply additional energy during the cooling from the molten phase. However, other energy source can also be employed such as, for example, heat radiators with a local limitation by means of, for example, diaphragms, resistance heating elements, Peltier elements, etc., that can locally introduce energy into the structurally modified seam region in a suitable way. In the example according to FIG. 1 with both-sided beam charging for welding the ends of the plastic film 10, it can suffice to undertake the additional energy application for the recrystallization from only one side.

A heat radiator that emits large-area can be employed for the thermal treatment by means of tempering. The heat ray is then simultaneously absorbed over the entire length of the weld. The radiation is limited with the assistance of diaphragms and/or a concave mirror.

When an amorphous, non-crystalline thermoplastic or a thermoplastic that already achieves its crystallinity again during the cooling phase from the melt is employed, then the additional recrystallization step can be foregone.

List of Reference Characters

10 plastic film

11 mounting element

11a pressing surface

12 counter-mounting element

12a pressing surface

13,14 pressing frame

15,17 radiation-conducting fiber

16,18 focussing optics

19 weld

20 radiation detector

30,31 clamp element

40,42 absorption device

50 absorbent coating

52 metal sheet

60 glass pane

62 absorbent layer

64 anti-adhesion layer

1. Method for manufacturing an endless band of plastic for an intermediate carrier band in an electrographic printer or copier,
whereby the ends of a thermoplastic, partially crystalline plastic film (10) that comprises at least the width of a standard printing format have their end faces placed abutting one another,
the ends of the plastic film (10) are heated by radiation to a temperature required for the welding,
and whereby a recrystallization step wherein the plastic material recrystallizes in the seam region ensues following the welding.

2. Method according to claim 1, characterized in that the recrystallization step comprises measures wherein the cooling phase for the plastic material in the seam region is lengthened.

3. method according to claim 1 or 2, whereby an energy application ensues in the recrystallization step.

4. Method according to claim 3, characterized in that the energy application ensues such that a predetermined temperature-time diagram is adhered to.

5. Method according to one of the preceding claims, characterized in that, following the cooling, the seam region is heated to a temperature below the melting temperature by means of an at least one-time re-application of energy.

6. Method according to claim 5, characterized in that a predetermined temperature-time diagram is adhered to.

7. Method according to one of the preceding claims, characterized in that the energy source with which the welding ensues is also employed for supplying energy for the recrystallization.

8. Method according to one of the preceding claims, characterized in that an additional energy source is employed for supplying the energy for the recrystallization.

9. Method according to one of the preceding claims, characterized in that a respective pressing surface (11a, 12a) is arranged at both sides of the ends, the length of said pressing surface at least corresponding to the width of the standard printing format and this pressing the surfaces of the ends against one another such that, when the plastic material of the end faces of the ends residing opposite one another melts, the spacing of the pressing surfaces (11a, 12a) defined by the thickness of the cold plastic film (10) is preserved.

10. Method according to one of the preceding claims, characterized in that the plastic film (10) is heated by radiation proceeding from one side.

11. Method according to claim one of the preceding claims, characterized in that the plastic film (10) is heated by radiation from both sides.

12. Method according to one of the preceding claims, characterized in that the plastic film (10) is simultaneously heated by radiation from both sides.

13. Method according to claim 12, characterized in that the plastic film (10) is heated by radiation at one side and, after being turned over, is subsequently heated further at the other side.

14. Method according to one of the preceding claims, characterized in that the heating of the plastic film (10) ensues by means of laser radiation.

15. Method according to one of the preceding claims, characterized in that the radiation is respectively absorbed at that side of the plastic film (10) facing toward the radiation source (15, 17).

16. Method according to one of the preceding claims, characterized in that the ends of the plastic film (10) residing opposite one another are pre-stressed relative to one another during the welding.

17. Method according to one of the preceding claims, characterized in that the temperature of the plastic film (10) at the weld (19) is measured during the welding process and/or the energy application for the recrystallization, and the radiation capacity is set or regulated dependent on the measured temperature.

18. Method according to one of the preceding, characterized in that the plastic film (10) is irradiated proceeding from one side and the radiation passing through a gap between the ends to be welded is detected at the other side.

19. Method according to one of the preceding claims, characterized in that the pressing surfaces (11a, 12a) are formed by plates.

20. Method according to claim 19, characterized in that at least one of the plates (11, 12) is composed of a material transparent for the radiation, preferably glass, whereby the plates preferably comprise an anti-adhesion layer of Teflon or a hydrophobic DLC layer.

21. Method according to one of the preceding claims, characterized in that the thickness of the plastic film (10) and the radiation delivered by the radiation source (15, 16) are matched to one another such that the optical penetration depth of the radiation is less than or equal to half the thickness of the plastic film (10).

22. Method according to one of the preceding claims, characterized in that an absorption device (40, 42) for absorbing rays is provided on at least one side of the plastic film (10) and lying thereagainst.

23. Method according to claim 22, characterized in that the absorption device (40, 42) lies in direct contact against the plastic film (10).

24. Method according to claim 22 or 23, characterized in that the absorption device (40, 42) forms the pressing surface (11a, 12a).

25. Method according to one of the preceding claims, characterized in that the absorption device (40, 42) is fashioned as metal sheet (52), preferably as CrNi steel sheet.

26. Method according to claim 25, characterized in that the metal sheet (52) preferably carries an absorbent coating (50), preferably of black chromium or stoving enamel.

27. Method according to one of the preceding claims 25 or 26, characterized in that the side of the metal sheet (52) facing toward the radiation source is roughened.

28. Method according to one of the preceding claims, characterized in that the absorption device (40, 42) is provided with an absorbent hard-aggregate layer or absorbent DLC layer, preferably having a thickness of 0.2-3 μm.

29. Method according to one of the preceding claims, characterized in that polyester, polycarbonate, PET or polyamide is employed as plastic film.

30. Method according to claim 29, characterized in that the plastic film is composed of polyamide filled with lampblack particles.

31. Method according to one of the preceding claims, characterized in that the width of the standard printing format for the plastic film (10) at least corresponds to the DIN A4 format.

32. Method according to one of the preceding claims, characterized in that the plastic film (10) has a thickness in the range from 20 through 500 μm, preferably in the range from 50 through 200 μm.

33. Device for manufacturing an endless band of plastic for an intermediate carrier band in an electrographic printer or copier,
whereby the ends of a thermoplastic plastic film (10) that comprises at least the width of a standard printing format have their end faces placed abutting one another,
the ends of the plastic film (10) are heated by radiation to a temperature required for the welding,
and whereby means are provided that effect a recrystallization of the plastic material recrystallizes.

34. Device according to claim 33, characterized in that means are provided with which the cooling phase for the plastic material in the seam region is lengthened.

35. Device according to claim 33 or 34, whereby an energy application ensues for the recrystallization.

36. Device according to claim 35, characterized in that the energy application ensues such that a predetermined temperature-time diagram is adhered to.

37. Device according to one of the preceding claims, characterized in that, following the cooling, the seam region is heated to a temperature below the melting temperature by means of an at least one-time re-application of energy.

38. Method according to one of the preceding claims, characterized in that the energy source with which the welding ensues is also employed for supplying energy for the recrystallization.

39. Method according to one of the preceding claims, characterized in that an additional energy source is employed for supplying the energy for the recrystallization.
